(19) United States
(12) Patent Application Publication
(10) Pub. No.: US 2003/0155814 A1
(43) Pub. Date: Aug. 21, 2003

(54) Device for power supply in a multi-voltage electric system of a motor vehicle

(76) Inventor: Roman Gronbach, Korntal (DE)

Correspondence Address: KENYON & KENYON, ONE BROADWAY, NEW YORK, NY, 10004, US

(21) Appl. No.: 10/312,204

(22) PCT Filed: Apr. 3, 2002
(86) PCT No.: PCT/DE02/01197

(30) Foreign Application Priority Data
Apr. 24, 2001 (DE) 10119985.6

(51) Int. Cl. H02B 1/24

(52) U.S. Cl. 307/130

(57) ABSTRACT

The invention relates to a power supply device of a dual voltage electric system of a motor vehicle. According to the invention, a dual voltage electric system of a motor vehicle is provided, that supplies a first and a second voltage level which differ from the reference voltage, wherein power is supplied from at least one electric energy accumulator (12, 24). At least one transformer for transforming both voltage levels (18, 28) is also provided. Supply means (34, 31, 32, 36, 20) are further provided for additional supply of the energy accumulator (12, 24).

### BACKGROUND INFORMATION

The present invention starts out from a device for supplying power to a multi-voltage on-board electrical system of a motor vehicle according to the definition of the species in the independent claim. Vehicle electrical systems having a plurality of electrical loads, for example motor vehicle electrical systems, have the problem that a 12V voltage is no longer sufficient for supplying power. Since some of the load circuits should be supplied with a voltage greater than 12 V, multi-voltage on-board electrical systems having two different voltage levels are known; thus, a first voltage level of +12 V with respect to ground and a second voltage level of +36 V with respect to ground, each of these voltages being the nominal voltages. The connection between the two voltage levels is produced with the aid of a DC/DC converter. This type of multi-voltage on-board electrical system in a motor vehicle is described in DE 198 45 569. The electrical power is generated in this electrical system with the aid of a three-phase generator that is driven by the vehicle engine and supplies an output voltage of 42 V (charging voltage). A 36V (nominal voltage) battery is charged by this charging voltage. A 12V battery is supplied with a charging voltage of 14 V, via a d.c. voltage converter. The two batteries can have the electrical load circuits connected to them via appropriate switches, with the 12V battery supplying the traditional electrical system loads, for example incandescent lamps, while the 36V battery is used to supply high-power load circuits such as window heaters. In the known vehicle electrical system, the negative terminals of the two batteries are each connected to the same ground potential.

The object of the present invention is to increase the operational reliability of a multi-voltage on-board electrical system. This object is achieved by the features of the independent claim.

### SUMMARY OF THE INVENTION

The device of the present invention for supplying energy to a multi-voltage on-board electrical system of a motor vehicle includes a multi-voltage on-board electrical system, which is situated in a motor vehicle and provides at least a first and second voltage level that are each different from the reference voltage. The multi-voltage on-board electrical system is powered by at least one electrical energy store. At least one converter is provided for connecting the two voltage levels. The present invention provides power-supply means for externally supplying power to the multi-voltage on-board electrical system of the motor vehicle. Therefore, a 42V vehicle having other electrical-system voltages may also be started by a start-assist device in a transition time, in which probably not all vehicles are equipped with a 42V electrical system.

In an advantageous, further refinement, the power-supply means are provided as an external point of support for charging, in order to disconnect one or more d.c. voltage converters (DC/DC converters) from the 42V electrical system and use this connection. The separated converters are operated as step-down transformers and supply power to the 14V vehicle electrical system, i.e. recharge its 14V battery. The remaining converter is used as a step-up transformer, in order to recharge the 42V battery for starting. In particular, access to a DC/DC converter has the following advantages. The twin-voltage on-board electrical system may be supplied with different charging voltages (for example 12V/24V/36V). The current in the jumper cable is limited by the capacity of the DC/DC converter. The use of a DC/DC converter as a current-limiting component allows a jumper cable to be used, which has a small copper cross-section in comparison with conventional jumper cables. The current-limiting effect of the DC/DC converter also allows the mechanical design of the external charging support point to be simplified. If one refers to regulated DC/DC converters, then the vehicle batteries may be charged in a selected manner, since current/voltage are now adjustable. Regulating or limiting the current of the step-down and step-up transformers allows the distribution of supplied power to the 14V or 42V battery to be adjusted as needed. The external charging cable may be protected against polarity reversal, when reverse-polarity protected DC/DC converters are used or a power diode having a comparatively low current loading is used.

Additional expedient refinements arise from additional dependent claims and from the specification.

### BRIEF DESCRIPTION OF THE DRAWING

Represented in the drawing and described in detail below are two exemplary embodiments of the device according to the present invention for supplying power to a multi-voltage on-board electrical system of a motor vehicle.

FIG. 1 shows a first exemplary embodiment and FIG. 2 a second exemplary embodiment of possible (external) power supplies.

### DESCRIPTION OF THE EXEMPLARY EMBODIMENTS

A generator 10, a 36V battery 12, a starter 14, and a high-current load circuit 16 are connected in parallel between a 42V branch 18 and ground potential. The 42V branch 18 is connected to a 14V branch 28 by a second DC/DC converter 22. A 12V battery 24 and 14V load circuits 26 are connected in parallel to this 14V branch 28 and ground. A first DC/DC converter 20 may be connected in parallel to second DC/DC converter 22, via a first switching element 31 situated on the 42V side, by closing first switching element 31. An external charging support point 34 may be connected to the 42V-side terminal of first DC/DC converter 20 by a second switching element 32.

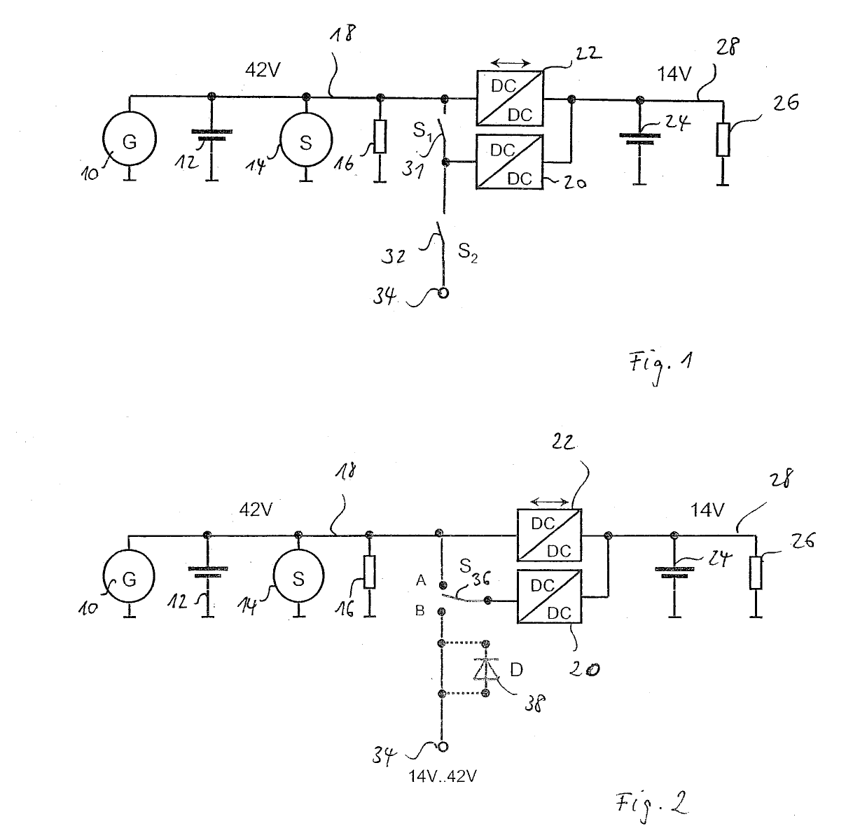

The exemplary embodiment according to FIG. 2 only differs from that of FIG. 1 in the connection of external charging support point 34. Thus, a two-way switching element 36 is provided, which either connects the 42V-side terminal of first DC/DC converter 20 to the potential of external charging support point 34 (position “B”) or to that of 42V branch 18 (position “A”). Optionally provided is a diode 38, which is positioned between external charging support point 34 and two-way switching element 36 (position “B”) to protect against polarity reversal.

In the case of conventional electrical-system configurations, DC/DC converters 20, 22 (d.c. voltage converters) are connected in parallel on the 42V side. According to the first exemplary embodiment, first switching element 31 is used to disconnect first DC/DC converter 20 from the 42V branch. A connection to external charging support point 34 may be established via second switching element 32. During normal operation of the vehicle, first switching element 31 is closed and second switching element 32 is opened. During normal operation, first DC/DC converter 20 is used in step-down operation to support the 14V voltage level via the 42V side, in the same way as parallelly connected, second DC/DC converter 22, which also functions as a step-down transformer during normal operation. Corresponding directional information (step-down operation) is provided to at least the second DC/DC converter 22 by a control unit not specifically represented. At least second DC/DC converter 22 may be operated bidirectionally (upward, downward), as is described below.

During charging operation, which deviates from normal operation, first switching element 31 is adjusted in the opening direction and second switching element 32 is adjusted in the closing direction by, for example, a control unit not shown. Therefore, electrical energy may be supplied to the 14V vehicle electrical system via external charging support point 34 and first DC/DC converter 20, and possibly supplied to the 42V vehicle electrical system via second DC/DC converter 22. First DC/DC converter 20 converts an arbitrary voltage level externally supplied via external charging support point 34, to a voltage suitable for the 14V vehicle electrical system. Because of the limited capacity of first DC/DC converter 20 (step-down transformer), the current intensity remains limited during external charging, meaning that switching elements 31, 32 may be realized by transistors or relays. When a switch sufficiently resistant to current is used, then it is also conceivable to establish a direct 42V connection with switches 31, 32 closed.

If, in a system having two DC/DC converters 20, 22, first DC/DC converter 20 is designed, for example, to have a wide-range input, then, during step-down operation, it can generate an output voltage of approximately 14 V from an input voltage of the 14 V to 42 V electrical system. By this means, power may be supplied to the rest of the 14V electrical system, and, in particular, 14V battery 24 may be recharged. If one simultaneously sets second DC/DC converter 22 to step-up operation, then the 42V system is also supplied with power and starter battery 12 is recharged on the 42V side. This may be accomplished, using controlled voltage. It is advisable for both DC/DC converters 20, 22 to operate with adjustable current limitation, or as a current source. In this manner, the output current provided by first DC/DC converter 20 may be arbitrarily divided up between the charging of 14V battery 24 and a step-up transformation to 42V and, thus, the recharging of 42V battery 12. A control unit not shown specifies directional information for second DC/DC converter 22, in order to adjust it for the charging case in step-up operation. If DC/DC converters 20, 22 are designed to be controlled, then the control unit could also specify the desired setpoint current and/or voltage values to converters 20, 22: These setpoint values could be a function of the state of charge of one or both batteries.

The switching of first switching element 31 and second switching element 32 from normal operation to external charging operation (e.g. by connecting external charging support point 34 to the multi-voltage on-board electrical system) may be triggered by a control-unit command, by the detection of an external charging cable being connected, or by the opening of a cover at external charging support point 34.

According to the second exemplary embodiment (FIG. 2), a polar relay in the form of two-way switching element 36 is provided as a simple and cost-effective option for realizing first and second switching elements 31, 32 of FIG. 1. By this means, a possibly undesirable, direct connection between external charging support point 34 and the 42V electrical system or the multi-voltage on-board electrical system is simultaneously prevented in a reliable manner.

An external charging cable holds the risk of reversing the polarity of the two terminals. In order to prevent damage in this case, e.g. second switching element 32 of FIG. 1 may be opened in the case of a polarity reversal. Other options include designing first DC/DC converter 20 to be resistant to polarity reversal or inserting a reverse-polarity protection diode 38 in the line of FIG. 2 leading to external charging support point 34. Switching elements 31, 32 may be realized by a relay, as well as by a semiconductor switch, or using a mechanical solution. For example, the raising of a cover above external charging support point 34 (in order to render it accessible) may automatically result in switch 36 being switched over from position A to position B. In order to protect external charging support point 34 against polarity reversal, i.e. in the case in which the jumper cables are reversed, switching element 36 must be switched into position A. This may be accomplished by switching relay 36 being appropriately controlled by the control unit, or by the relay control coil of two-way switching element 36 being connected in series with a diode. Relay 36 has break contact A, and, when the voltage at external charging support point 34 is correct, the relay is traversed by a current and consequently switches to B. In the event of a polarity reversal, the diode becomes blocked and the relay does not respond.

The external battery-charging support occurs via first DC/DC converter 20 in step-down operation, and via second DC/DC converter 22 in step-up operation. However, the two converters 20, 22 do not have to be two separate converters. Some of today's DC/DC converters are also designed as multiphase converters. This means that, on these converters, several converter cells of lower capacity are connected in parallel, and the power circuits are clocked in a time-staggered manner. This allows filter components to be dispensed with on account of the effects of destructive interference. Multiphase converters now allow first and second converters 20, 22 to be realized by the available phases of a single multiphase converter. To this end, the phases are divided up into a converter having the function of a step-down and step-up transformer. The phases are then separated inside the converter, on the input side, via a switch.

In addition, the device could analogously be used to provide energy at external charging support point 34, using the multi-voltage on-board electrical system. For example, the cigarette lighter could be used as external charging support point 34. In order to supply it with power from the multi-voltage on-board electrical system, a further operating state must be provided, in which the two switching elements 31, 32 of FIG. 1 are closed. If power is now supplied through the cigarette lighter and the jumper cable is plugged in for this reason, then, e.g. an evaluation device integrated in the control unit detects that a voltage is being applied. As a result, first switching element 31 is adjusted in the opening direction, in order to achieve the charging operation described above.

What is claimed is:

1. A device for supplying power to a multi-voltage on-board electrical system of a motor vehicle, comprising a multi-voltage on-board electrical system, which is situated in a motor vehicle, provides at least a first and a second voltage level (18, 28) that are both different from the reference potential, and is powered by at least one electrical energy store (12, 24); and at least one converter (20, 22) for connecting the two voltage levels (18, 28);
wherein supply means (20, 31, 32, 34, 36) are provided for externally supplying power to the multi-voltage on-board electrical system.

2. The device as recited in claim 1,
wherein the supply means (20, 31, 32, 34, 36) include at least one switching element (32, 36), across which an external support point for charging (34) is electroconductively connectible to the multi-voltage on-board electrical system.

3. The device as recited in one of the preceding claims,
wherein the external charging support point (34) is connectible to the second voltage level (28) via the converter (20).

4. The device as recited in one of the preceding claims,
wherein the supply means (20, 31, 32, 34, 36) disconnect at least one converter (20) from a voltage level (18) of the multi-voltage on-board electrical system, in order to use this terminal as an external charging support point (34) for externally supplying power.

5. The device as recited in one of the preceding claims,
wherein at least one switching element (31, 36) is provided, in order to disconnect the converter (20) from the first voltage level (18).

6. The device as recited in one of the preceding claims,
wherein, when power is externally supplied, the converter (20) is disconnected from the first voltage level (18).

7. The device as recited in one of the preceding claims,
wherein at least two parallelly connected converters (20, 22) are provided.

8. The device as recited in one of the preceding claims,
wherein at least one multiphase converter is provided as a converter (20, 22).

9. The device as recited in one of the preceding claims,
wherein the switching elements (31, 32, 36) are controlled as a function of a switching-element signal generated in connection with a cable being plugged into the external charging support point (34).

10. The device as recited in one of the preceding claims,
wherein means for protecting against polarity reversal (20, 38) are provided.

11. The device as recited in one of the preceding claims,
wherein the converter (20, 22) may be operated in a current-controlled and/or voltage-controlled manner.

12. The device as recited in one of the preceding claims,
wherein the converter (22) may be controlled in step-up operation and in step-down operation.

13. The device as recited in one of the preceding claims,
wherein the converter (22) is controlled in step-down mode during normal operation, and controlled in step-up mode during charging operation.

14. The device as recited in one of the preceding claims,
wherein a cigarette lighter is used as an external charging support point (34).

15. The device as recited in one of the preceding claims,
wherein the external charging support point (34) is provided for extracting power from the multi-voltage on-board electrical system.
